(19) United States
(12) Patent Application Publication
(10) Pub. No.: US 2020/0346433 A1
(43) Pub. Date: Nov. 5, 2020

(54) Bonding Method

(71) Applicant: Marelli Corporation, Saitama-shi, Saitama (JP)

(72) Inventors: Teruyoshi Mihara, Saitama-shi, Saitama (JP); Tomihito Hashimoto, Saitama-shi, Saitama (JP); Yuusuke Nakata, Saitama-shi, Saitama (JP); Motoki Kurasawa, Saitama-shi, Saitama (JP)

(21) Appl. No.: 16/632,749

(22) PCT Filed: Jul. 4, 2018
(86) PCT No.: PCT/JP2018/025394

§ 371 Date: Jan. 21, 2020

(30) Foreign Application Priority Data
Jul. 24, 2017 (JP) 2017-142961

(51) Int. Cl. B32B 7/025; B32B 37/00; B32B 15/04; H01M 8/24; H01M 8/0247; H01M 8/1246; H01M 4/90

(52) U.S. Cl. CPC B32B 7/025; B32B 37/00; B32B 15/04; H01M 2008/1293; H01M 8/0247; H01M 8/1246; H01M 4/9025; H01M 8/24

(57) ABSTRACT

A bonding method is capable of firmly bonding a greater variety of materials using an electrochemical reaction. The bonding method includes a placement step of placing an oxygen ion conductor and a conductive member that includes an oxide layer on a surface thereof in contact with each other via the oxide layer, a connection step of connecting the oxygen ion conductor to the positive electrode side of a voltage application device and connecting the conductive member to the negative electrode side of the voltage application device, and a voltage application step of applying voltage between the oxygen ion conductor and the conductive member to bond the oxygen ion conductor and the conductive member.

### CROSS-REFERENCE TO RELATED APPLICATION(S)

This application claims priority to Japanese Application Patent Serial No. 2017-142961, filed Jul. 24, 2017, the entire disclosure of which is hereby incorporated by reference.

### TECHNICAL FIELD

The present disclosure relates to a bonding method.

### BACKGROUND

One known method for bonding materials by an electrochemical reaction is anodic bonding. For example, see JP2007-83436A. Anodic bonding is a method for placing glass and a member to be bonded in contact and bonding by applying a direct current (DC) voltage therebetween, with the side of the member to be bonded as the anode and the side of the glass as the cathode.

### SUMMARY

Materials can be firmly bonded by the aforementioned anodic bonding method. However, bondable materials are limited to glass and metal, semiconductors, or the like, and uses are limited.

The present disclosure was conceived focusing on the aforementioned problem and proposes a bonding method capable of firmly bonding a greater variety of materials using an electrochemical reaction.

To resolve the aforementioned problem, a bonding method according to a first aspect includes a placement step of placing an oxygen ion conductor and a conductive member that includes an oxide layer on a surface thereof in contact with each other via the oxide layer;

a connection step of connecting the oxygen ion conductor to a positive electrode side of a voltage application device and connecting the conductive member to a negative electrode side of the voltage application device; and

a voltage application step of applying voltage between the oxygen ion conductor and the conductive member to bond the oxygen ion conductor and the conductive member.

The present disclosure allows firm bonding of a greater variety of materials using an electrochemical reaction.

### BRIEF DESCRIPTION OF THE DRAWINGS

In the accompanying drawings:

FIG. 1 is a flowchart of a bonding method according to the present disclosure;

FIG. 2 illustrates a method for bonding an oxygen ion conductor and a conductive member;

FIGS. 3A to 3D illustrate an example of bonding an oxygen ion conductor and two metals;

FIGS. 4A to 4D illustrate an example of linking two pipes via an oxygen ion conductor packing;

FIGS. 5A to 5E illustrate an example of linking two pipes using bonding seal tape;

FIG. 6 illustrates the structure of a single cell in a solid oxide fuel cell (SOFC);

FIGS. 7A to 7C illustrate an example of producing a cell stack; and

FIGS. 8A to 8C illustrate another example of producing a cell stack.

### DETAILED DESCRIPTION

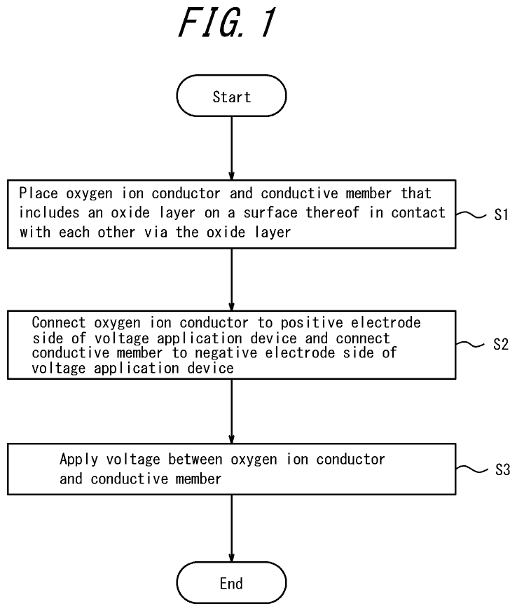

The bonding method of the present disclosure is described below with reference to the drawings. FIG. 1 is a flowchart of a bonding method according to the present disclosure. A bonding method according to the present disclosure includes a placement step (step S1) of placing an oxygen ion conductor and a conductive member that includes an oxide layer on a surface thereof in contact with each other via the oxide layer, a connection step (step S2) of connecting the oxygen ion conductor to a positive electrode side of a voltage application device and connecting the conductive member to a negative electrode side of the voltage application device, and a voltage application step (S3) of applying voltage between the oxygen ion conductor and the conductive member to bond the oxygen ion conductor and the conductive member.

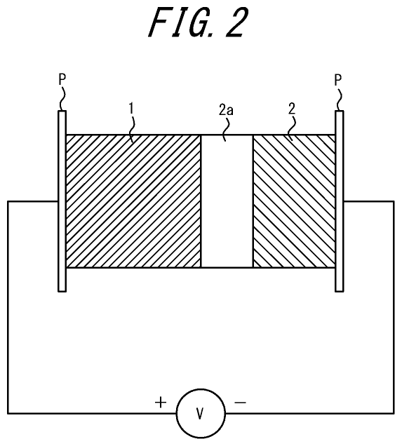

To establish a bonding method capable of bonding a greater variety of materials than with a known anodic bonding method, we attempted to bond various materials under various conditions. We discovered that placing an oxygen ion conductor 1 and a conductive member 2 that includes an oxide layer 2a on a surface thereof in contact with each other via the oxide layer 2a, connecting the oxygen ion conductor 1 to the positive electrode side of a voltage application device and connecting the conductive member 2 to the negative electrode side of the voltage application device, and applying a direct current (DC) voltage, as illustrated in FIG. 2, yielded a firm bond between the oxygen ion conductor 1 and the conductive member 2.

The reason why the firm bond is formed is thought to be that upon application of voltage between the oxygen ion conductor 1 and the conductive member 2, a reduction reaction such as in Formula (1) below occurs between the oxygen ion conductor (X—O) 1 and the oxide layer (R—O) 2a.

X—O+R—O+2e X—O—R+O²⁻ (1)

The oxide forming the oxide layer (R—O) 2a of the conductive member 2 is reduced by this reduction reaction, and a bond (X—O—R) is formed between the material (R) of the reduced oxide and the oxygen ion conductor (X—O) 1. The oxygen ion conductor 1 and the conductive member 2 are thereby bonded firmly at the contact surfaces. On the other hand, the O^{2'} ions generated by the reduction reaction migrate through the oxygen ion conductor 1 to the anode side and are emitted. It is thus thought that a firm bond is formed between the oxygen ion conductor 1 and the conductive member 2 as a result of the reduction reaction occurring in the conductive member 2 at the cathode side.

The reduction reaction expressed in Formula (1) above is thought to contrast with the electrochemical reaction that occurs in a known anodic bonding method. Specifically, it is thought that when glass (X—O—Na) and metal (M), for example, are bonded with an anodic bonding method, oxidation reactions such as Formulas (2) to (4) below occur between the glass (X—O—Na) and the metal (M).

X—O—Na→X—O⁻+Na⁺ (2)

X—O⁻+M X-O-M+e (3)

Na⁺+e Na (4)

The reactions in Formulas (2) and (3) are reactions occurring at the anode side (contact interface). Na is ionized and separates, yielding X—O⁻, which joins with M to form a bond. On the other hand, the reaction in Formula (4) is a reduction reaction occurring at the cathode side, where Na⁺ ions that migrated in the glass towards the cathode side pick up an electron and are reduced to Na.

The bonding method of the present disclosure, based on a reduction reaction at the cathode, is thus a new bonding method that contrasts with a known anodic bonding method based on an oxidation reaction at the anode. With respect to a known anodic bonding method, we call our bonding method a “cathodic bonding method”. The cathodic bonding method of the present disclosure allows the oxygen ion conductor 1 and the conductive member 2 having the oxide structure 2a on the surface therefore to be firmly bonded. Furthermore, a greater variety of materials can be bonded than with a known anodic bonding method.

As is clear from Formulas (2) to (4) above, Na⁺ is what carries electricity in the glass, without intervention of independent O²⁻. Na precipitates at the cathode side, which may become a source of contamination or cause plating to peel at the interface in the case of the glass being plated. With respect to this point, independent O²⁻ is responsible for oxygen ion conduction in the present disclosure. A bond corresponding to both oxidation and reduction is therefore formed. Since oxygen is a gas, the problems of contamination or peeling of plating occurring in the aforementioned reactions in glass do not occur. Each step of the present disclosure is described below.

First, in step S1, the oxygen ion conductor 1 and the conductive member 2 that includes the oxide layer 2a on a surface thereof are placed in contact with each other via the oxide layer 2a (placement step). For example, as illustrated in FIG. 2, the oxygen ion conductor 1 and the conductive member 2 are placed in contact via the oxide layer 2a.

The oxygen ion conductor 1 is a layer that has the characteristic of transmitting oxygen ions. The material of the oxygen ion conductor 1 may be any material that transmits oxygen ions but is preferably an oxide ion conductor. For example, yttria (Y₂O₃)-doped stabilized zirconia (YSZ), neodymium oxide (Nd₂O₃), samaria (Sm₂O₃), gadria (Gd₂O₃), scandia (Sc₂O₃), or the like can be used. Other examples include bismuth oxide (Bi₂O₃), cerium oxide (CeO), zirconium oxide (ZrO₂), lanthanum gallate oxide (LaGaO₃), indium barium oxide (Ba₂In₂O₅), nickel lanthanum oxide (La₂NiO₄), and potassium nickel fluoride (K₂NiF₄).

The material of the oxygen ion conductor 1 is not limited to these examples, and any other known oxygen ion conductor material can be used. One type of these materials may be used alone, or a plurality may be used in combination.

A representative example of a material that can be used as the oxygen ion conductor 1 is obtained with a hot press method by mixing a powder or raw material with an organic binder, applying pressure to spread the material thinly, and pressure sintering the material in a high-temperature furnace. A sol-gel method can be used to form the oxygen ion conductor 1 as a thinner film.

Any material that is conductive and allows formation of a covalent bond with the oxygen in the oxide layer 2a can be used as the conductive member 2 in the present disclosure. For example, metal or a semiconductor (Si, SiC, GaN, or the like) can be used. Various types of metal or the like, such as SUS, can be used as the metal. The bonded oxygen ion conductor 1 and conductive member 2 can be a portion of a single solid oxide fuel cell (“SOFC” or “fuel cell”). That is, the oxygen ion conductor 1 can be a solid electrolyte formed by YSZ or the like, and the conductive member 2 can be an electrode member for air electrodes or fuel electrodes connected to both sides of the solid electrolyte. The SOFC normally operates at a high temperature of 800° C. or higher. A material that can withstand such high temperatures and that does not suffer electric corrosion due to a redox reaction at the time of electricity generation is therefore preferably selected. In this case, a metal covered by nickel or Si (including SUS), which is well known as a stable electrode material for SOFCs and has demonstrated high performance as a barrier metal that suppresses an alloy reaction in a high-temperature environment between multilayer materials, can be used for the conductive member 2 that serves as an electrode member.

The oxide layer 2a is a layer formed by an oxide provided on the surface of the conductive member 2. The oxide layer 2a can, for example, be a thermal oxide film formed by thermal oxidation of the surface of the conductive member 2 or an oxide film formed on the surface of the conductive member 2 by a chemical vapor deposition (CVD) method or a physical vapor deposition (PVD) method. A natural oxide film formed on the surface of the conductive member 2 can also be used.

The oxide layer 2a preferably has electron conductivity. The oxide forming the oxide layer 2a can thereby efficiently be reduced. Such an oxide layer 2a having electron conductivity can be configured by an n-type oxide semiconductor. In other words, the electrons in the n-type dopant are excited to the conduction band at a lower temperature than the intrinsic temperature, providing the n-type oxide semiconductor with electron conductivity. The oxide layer 2a is therefore preferably configured by an n-type oxide semiconductor that has electron conductivity at the temperature during bonding. Usable examples of such n-doped oxide semiconductors include zinc oxide (ZnO), indium tin oxide (ITO), and tin oxide (TiO).

Even if the oxide layer 2a is an insulating film that does not have electron conductivity, the oxide layer 2a can be provided with electron conductivity by being formed thinly enough for electrons to be capable of passing (tunneling) through the oxide layer 2a in the thickness direction thereof. The specific thickness of the oxide layer 2a in this case depends on the oxide configuring the oxide layer 2a and therefore cannot be unconditionally prescribed. However, when the conductive member 2 is configured by a metal, for example, electrons can pass through in the thickness direction if the conductive member 2 is a thermal oxide film with a thickness of approximately 50 angstroms.

When the placement step is performed, the contact surfaces of the oxygen ion conductor 1 and the conductive member 2 are preferably processed for close contact with each other. In the present disclosure, the contact surfaces of the oxygen ion conductor 1 and the conductive member 2 are brought together firmly by electrostatic attraction through application of a high voltage of several 100 V. When the contact surfaces approach each other to an interatomic distance, covalent bonds are formed by the above-described electrochemical reaction between atoms of the contact surfaces that are close to each other. The degree of flatness of the surfaces to be bonded is therefore crucial, and finishing as close as possible to a mirror surface is preferable. Specifically, the contact surfaces of the oxygen ion conductor 1 and the conductive member 2 are preferably finished to be flat by a mirror polishing process, or at least one of the oxygen ion conductor 1 and the conductive member 2 is preferably configured thinly to allow close contact. The bonding strength between the oxygen ion conductor 1 and the conductive member 2 can thereby be increased.

Next, in step S2, the oxygen ion conductor 1 is connected to the positive electrode side of a voltage application device V, and the conductive member 2 is connected to the negative electrode side of the voltage application device V (connection step). For example, the oxygen ion conductor 1 is placed in contact with the electrode plate P connected to the positive electrode of the voltage application device V, and the opposite side of the conductive member 2 from the oxide layer 2a is placed in contact with the electrode plate P connected to the negative electrode of the voltage application device V, as illustrated in FIG. 2.

This connection step does not refer to “directly” connecting the oxygen ion conductor 1 to the positive electrode side of the voltage application device V and the conductive member 2 to the negative electrode side of the voltage application device V. In other words, the connection step refers to connection to the voltage application device V so that, in step S3 described below, voltage is applied between the oxygen ion conductor 1 and the conductive member 2 while the potential of the oxygen ion conductor 1 is higher than the potential of the conductive member 2.

Next, in step S3, a DC voltage is applied between the oxygen ion conductor 1 and the conductive member 2 (voltage application step). Specifically, while the oxygen ion conductor 1 and the conductive member 2 are heated, voltage is applied between the electrode plate P on the positive electrode side and the electrode plate P on the negative electrode side, as illustrated in FIG. 2. The oxygen ion conductivity of the oxygen ion conductor 1 rises as the temperature rises, and the oxygen ion conductor 1 allows electricity to flow. Consequently, the oxygen ion conductor 1 and the oxide layer 2a are bonded, thereby bonding the oxygen ion conductor 1 and the conductive member 2.

The voltage applied between the oxygen ion conductor 1 and the conductive member 2 has an optimal range corresponding to the temperature, since the resistance of the oxygen ion conductor changes with the operating temperature. Selection is made for optimal results in accordance with use, taking into account the material properties of the oxygen ion conductor 1 and the usage conditions after bonding. If the operating temperature and the voltage are too low, the oxygen ion conductivity of the oxygen ion conductor 1 decreases, lengthening the time required for bonding. Conversely, if the temperature is high, the time required for bonding shortens, but the residual stress after bonding increases. This is unsuitable in terms of durability. Excessively high voltage also makes bonding difficult, as discharge occurs to portions other than the bonding portion. Optimal values are preferably selected in the typical ranges of a temperature of 300° C. or higher to 500° C. or lower and a voltage of 50 V or higher to 500 V or lower. A firmer bond can thus be formed between the oxygen ion conductor 1 and the conductive member 2.

Next, the time for which voltage is applied between the oxygen ion conductor 1 and the conductive member 2 is described. At the contact surfaces of the conductive member 2 that becomes the negative electrode and the oxygen ion conductor 1, the oxide forming the oxide layer 2a of the conductive member 2 is reduced, and strong covalent bonds are formed between the reduced oxide material and the oxygen ion conductor 1. The conductive member 2 and the oxygen ion conductor 1 are chemically bonded in this way. At this time, the oxygen ions generated by the reduction reaction with the oxide layer 2a migrate within the oxygen ion conductor 1 and are emitted, but current tends to increase while the bonding area between the conductive member 2 and the oxygen ion conductor 1 is expanding. When the bonding is nearly complete, the current starts to decrease. The point at which the current starts to decrease is preferably taken as a guide for stopping application of voltage. A firm bond can thus be formed between the oxygen ion conductor 1 and the conductive member 2 over the entire bonding surface.

After the (DC) voltage application step in step S3, an alternating current (AC) voltage is preferably applied between the oxygen ion conductor 1 and the conductive member 2 (AC voltage application step). If only the (DC) voltage application step is performed, reduction of the oxide layer 2a might be incomplete. Therefore, after the aforementioned voltage application step, an AC voltage is applied between the oxygen ion conductor 1 and the conductive member 2. Repetition of this DC/AC voltage application allows portions that are not completely reduced to be temporarily oxidized and then reduced again. Unreacted, unbound, or incompletely placed atoms in the bonding portion of the oxygen ion conductor 1 and the oxide layer 2a can be transitioned to a more stable state. This can further strengthen the bond between the oxygen ion conductor 1 and the oxide layer 2a.

The frequency of the AC voltage in the AC voltage application step is preferably set to a lower frequency than the frequency corresponding to the time necessary for an incompletely joined portion at the bonding surface to experience a redox reaction.

The oxygen ion conductor 1 and the oxide layer 2a can be bonded in this way, thereby bonding the oxygen ion conductor 1 and the conductive member 2. The bonding method of the present disclosure uses the cathodic bonding method based on a reduction reaction to allow a greater variety of materials to be firmly bonded than with a known anodic bonding method.

When the placement step is performed, the bonding strength between the oxygen ion conductor 1 and the conductive member 2 can be increased by the contact surfaces of the oxygen ion conductor 1 and the conductive member 2 being processed to be in close contact.

The oxide forming the oxide layer 2a can efficiently be reduced by the oxide layer 2a having electron conductivity. Such an oxide layer 2a having electron conductivity can be configured by an n-type oxide semiconductor. Even if the oxide layer 2a is an insulating film that does not have electron conductivity, the oxide layer 2a can be provided with electron conductivity by being formed thinly enough for electrons to be capable of passing through the oxide layer 2a in the thickness direction thereof.

By the oxygen ion conductor 1 being an oxide ion conductor, O²⁻ ions can be caused to migrate well through the oxygen ion conductor 1 to the anode side and be emitted.

After the (DC) voltage application step, an AC voltage is applied between the oxygen ion conductor 1 and the conductive member 2, thereby allowing portions that are not completely reduced to be temporarily oxidized and then reduced again. Consequently, unreacted, unbound, or incompletely placed atoms in the bonding portion of the oxygen ion conductor 1 and the oxide layer 2a can be transitioned to a more stable state. This can further strengthen the bond between the oxygen ion conductor 1 and the oxide layer 2a.

### EXAMPLES

Several examples of the present disclosure are described below, but the present disclosure is not limited to these examples.

### Example 1

### Bonding Two Metals Having Oxide Layers

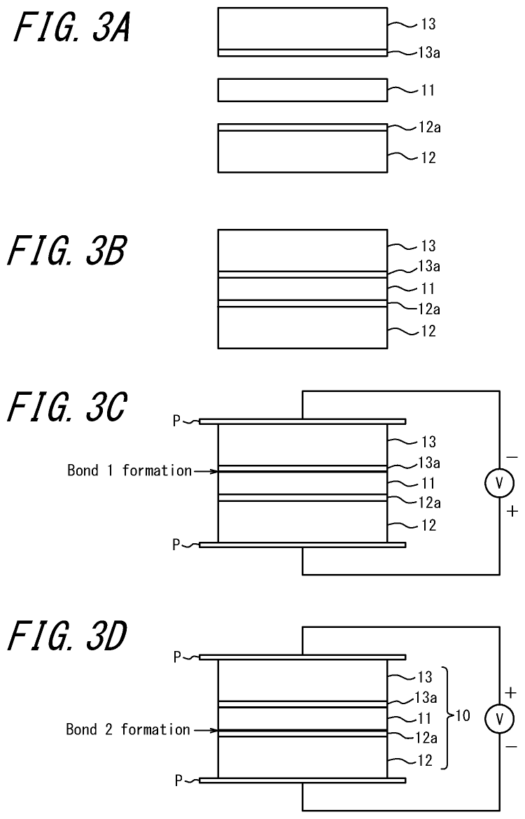

In the present example, two metals having oxide layers are bonded. FIG. 3A illustrates an oxygen ion conductor 11 and metals 12, 13. An oxide layer 12a is formed on one surface of the metal 12, and an oxide layer 13a is formed on one surface of the metal 13. As illustrated in FIG. 3B, the metals 12, 13 are placed on the surfaces of the oxygen ion conductor 11 with the oxide layers 12a, 13b therebetween.

Next, as illustrated in FIG. 3C, the metal 13 is connected to the electrode plate P on the negative electrode side of the voltage application device V, and the metal 12 is connected to the electrode plate P on the positive electrode side. DC voltage is applied between the metal 12 and the metal 13 while the oxygen ion conductor 11 and the metals 12, 13 are heated. Consequently, a bond (bond 1) is formed between the oxygen ion conductor 11 and the oxide layer 13a of the metal 13.

Next, as illustrated in FIG. 3D, the polarity of the voltage applied between the metal 12 and the metal 13 is reversed, and DC voltage is applied between the metal 12 and the metal 13 while the oxygen ion conductor 11 and the metals 12, 13 are heated. Consequently, a bond (bond 2) is formed between the oxygen ion conductor 11 and the oxide layer 12a of the metal 12. By thus applying DC voltage twice, the oxygen ion conductor 11 and the two metals 12, 13 can be firmly bonded to form a laminate 10.

### Example 2

### Connecting Two Pipes Via Packing

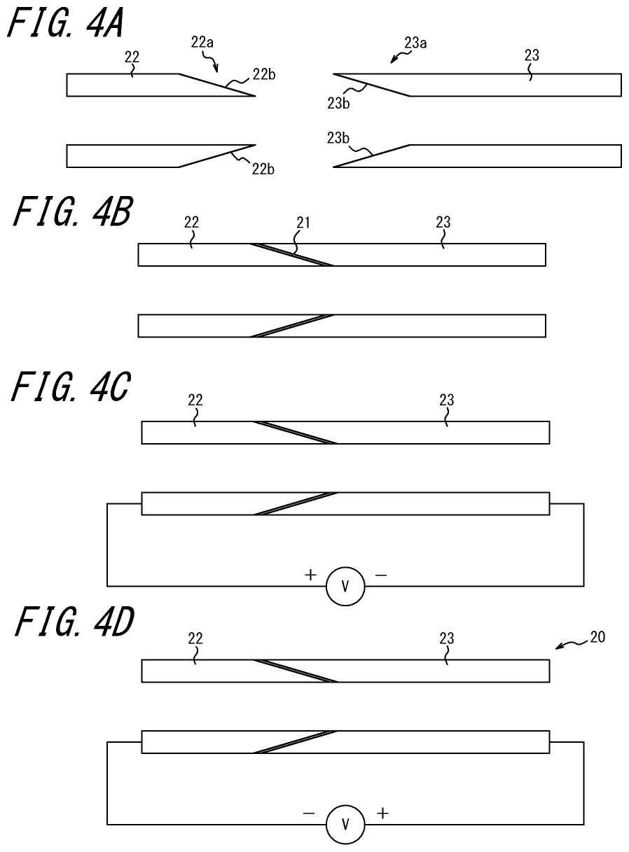

In the present example, two pipes that are for high-temperature gas or liquid, and for which resin or rubber material packing cannot be used, are connected. FIG. 4A illustrates cross-sections of two pipes 22, 23 to be connected. As illustrated in FIG. 4A, an end 22a of one pipe 22 is tapered towards the tip. An oxide layer 22b is formed by oxidation treatment on at least the outer peripheral surface of the end 22a. On the other hand, an end 23a of the other pipe 23 increases in diameter towards the tip. An oxide layer 23b is formed by oxidation treatment on at least the inner peripheral surface of the end 23a.

The end 22a of the pipe 22 and the end 23a of the pipe 23 are connected via packing 21 formed by an oxygen ion conductor, as illustrated in FIG. 4B. The oxide layer 22b of the pipe 22 and the packing 21 are thereby placed in contact with each other, and the oxide layer 23b of the pipe 23 and the packing 21 are placed in contact with each other.

As illustrated in FIG. 4C, the pipe 22 is then connected to the positive electrode side of the voltage application device V and the pipe 23 to the negative electrode side, and DC voltage is applied between the pipe 22 and the pipe 23 while the packing 21 and pipes 22, 23 overall are heated. The packing 21 and the oxide layer 23b of the pipe 23 are thus bonded.

Subsequently, the polarity of voltage applied between the pipe 22 and the pipe 23 is reversed, and DC voltage is applied between the pipe 22 and the pipe 23 while the packing 21 and pipes 22, 23 overall are heated, as illustrated in FIG. 4D. The packing 21 and the oxide layer 22b of the pipe 22 are thus firmly bonded. The pipe 22 and the pipe 23 are thereby integrated to yield a connected pipe 20 as illustrated in FIG. 4D.

### Example 3

### Connecting Two Pipes Via Bonding Seal Tape

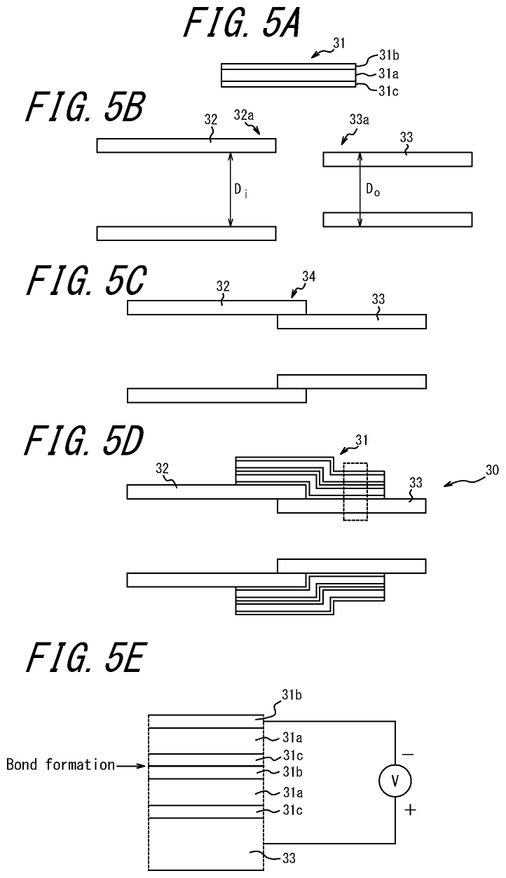

In the present example, two pipes that are for high-temperature gas or liquid, and for which resin or rubber material packing cannot be used, are connected using bonding seal tape with high-temperature endurance. FIG. 5A illustrates a cross-section of bonding seal tape used to connect the aforementioned two pipes. This bonding seal tape 31 includes a flexible metal tape member 31a, an oxygen ion conductor thin film 31b formed by a CVD method or a PVD method on one surface of the metal tape member 31a, and an oxide layer 31c formed by thermal oxidation, a CVD method, or a PVD method on the other surface of the metal tape member 31a.

FIG. 5B illustrates cross-sections of two pipes 32, 33 to be connected. The pipes 32, 33 are configured so that the inner diameter Dᵢ of the pipe 32 and the outer diameter Dₒ of the pipe 33 substantially match. As illustrated in FIG. 5C, an end 33a of the pipe 33 is inserted into an end 32a of the pipe 32 to connect the pipe 32 and the pipe 33.

Subsequently, the bonding seal tape 31 is wound around a connecting portion 34 where the pipe 32 and the pipe 33 are connected so that at least a portion of the bonding seal tape 31 is in overlap, as illustrated in FIG. 5D. The bonding seal tape 31 is wound twice so as to overlap itself completely in FIG. 5D. The bonding seal tape 31 is wound so that the oxide layer 31c contacts the outer surface of the pipe 33. The tape is thus formed to have a layered structure, as illustrated in FIG. 5D.

As illustrated in FIG. 5E, the oxygen ion conductor thin film 31b on the outermost surface of the laminated structure is connected to the negative electrode side of the voltage application device V and the pipe 33 to the positive electrode side, and DC voltage is applied between the oxygen ion conductor thin film 31b on the outermost surface of the laminated structure and the pipe 33 while the bonding seal tape 31 and the pipes 32, 33 overall are heated. In the laminated structure of the bonding seal tape 31 the oxygen ion conductor thin film 31b and the oxide layer 31c are thereby firmly bonded, integrating the pipe 32 and the pipe 33. The pipe 32 and the pipe 33 are connected in this way to yield the pipe 30 illustrated in FIG. 5D.

### Example 4

### Production of Solid Electrolyte Fuel Cell (SOFC)

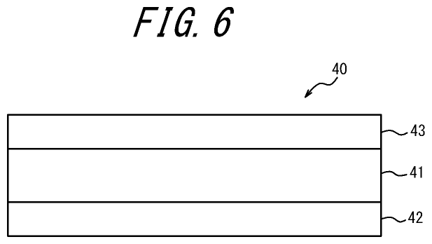

In the present example, a fuel cell using a solid electrolyte (SOFC) is produced. FIG. 6 illustrates a fuel cell (single cell) that is the electricity-generating unit in an SOFC. The single cell 40 illustrated in FIG. 6 has an anode member 42 on one surface of a solid electrolyte layer 41 and a cathode member 43 on the other surface.

The solid electrolyte layer 41 is an oxygen ion conductor such as YSZ. In the present example, the anode member 42 is formed from an oxide material having electron conductivity so that the single cell 40 that is ultimately formed becomes an oxygen ion conductor overall. For example, the anode member 42 can be formed by a mixture (cermet) of Ni and solid electrolyte layer material. The cathode member 43 is formed by an oxide material having oxygen ion conductivity and electronic mixed conductivity. Usable examples of this oxide material include La(Sr)MnO₃, La(Sr)FeO₃, La(Sr)CoO₃, and LaNiO₄.

The single cell 40 illustrated in FIG. 6 can, for example, be formed by paste printing the material for the anode member 42 on one surface of the solid electrolyte layer 41 and the material for the cathode member 43 on the other surface and then firing. The single cell 40 can also be formed by lamination of thin films of the anode member 42, the solid electrolyte layer 41, and the cathode member 43 using a PVD method. Furthermore, the single cell 40 can be formed by cathodic bonding, with the solid electrolyte layer 41 as the oxygen ion conductor 11 and the anode member 42 and cathode member 43 as the metals 12, 13, as described with reference to FIGS. 3A to 3D.

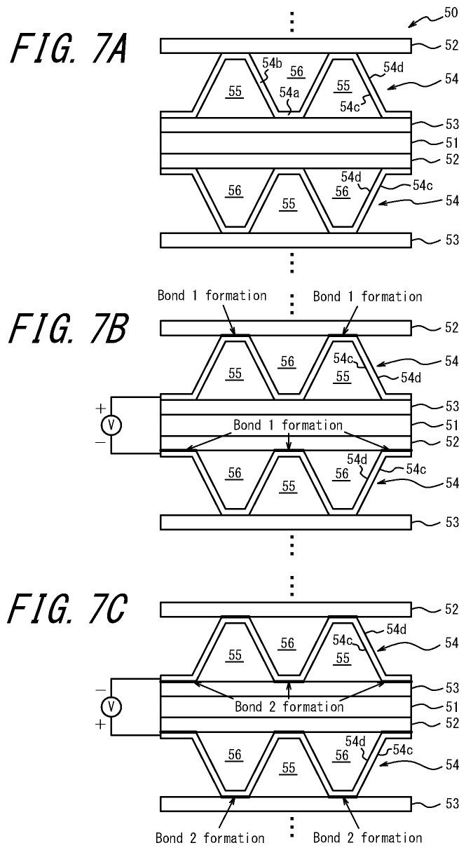

FIG. 7A illustrates a cell stack in which a plurality of single cells are stacked via separators. The cell stack 50 illustrated in FIG. 7A includes a plurality of single cells and a plurality of separators 54. Each single cell includes a solid electrolyte layer 51, an anode member 52, and a cathode member 53. In the cell stack 50, the anode members 52 function as fuel electrodes, and the cathode members 53 function as air electrodes. Each separator 54 is formed from metal, is configured to have a trapezoidal cross-sectional shape by press-molding, and includes flat plate portions 54a and standing plate portions 54b. The separator 54 is subjected to oxidation treatment to provide oxide layers 54c, 54d on the surfaces thereof. The anode member 52 is arranged on one surface of the solid electrolyte layer 51 and the cathode member 53 on the other to configure a single cell. These single cells are connected in series in the lamination direction to form the cell stack 50.

The separator 54 with a trapezoidal wave for a cross-sectional shape is stacked with the solid electrolyte layer 51, the anode member 52, and the cathode member 53 as a laminate, thereby forming oxidant gas flow channels 55 and fuel gas flow channels 56 between the solid electrolyte layer 51 and the anode member 52 or the cathode member 53. The cell stack 50 illustrated in FIG. 7A is configured so that the phases of the trapezoidal waves of separators 54 facing each other with the laminate of the solid electrolyte layer 51, the anode member 52, and the cathode member 53 therebetween are inverted. Consequently, the fuel gas flow channels 56 are disposed directly above the oxidant gas flow channels 55. Oxygen ions generated in the cathode member (air electrode) 53 can migrate through the solid electrolyte layer 51 to the fuel gas flow channels 56 directly above and react with the fuel gas, and the ionic conduction resistance can be reduced.

The cell stack 50 illustrated in FIG. 7A is obtainable in the following way. First, a laminate including the solid electrolyte layer 51, the anode member 52, and the cathode member 53 is formed. The laminate can, for example, be formed by paste printing the material for the anode member 52 on one surface of the solid electrolyte layer 51 and the material for the cathode member 53 on the other surface and then firing. The laminate can also be formed by lamination of thin films of the anode member 52, the solid electrolyte layer 51, and the cathode member 53 using a PVD method. The materials of the solid electrolyte layer 51, the anode member 52, and the cathode member 53 are the same as those of the single cell 40 illustrated in FIG. 6. The laminates (single cells) formed in this way each become an oxygen ion conductor overall.

Next, the laminates and the separators 54 are stacked as illustrated in FIG. 7A. As described above, the oxide layers 54c, 54d are formed on the surface of each separator 54. Each separator 54 is therefore arranged to be in contact with the anode member 52 or the cathode member 53, which are oxygen ion conductors, via the oxide layers 54c, 54d. Subsequently, while the entire structure is heated, all of the cathode members 53 are connected to the positive electrode side of the voltage application device V, all of the anode members 52 are connected to the negative electrode side, and a DC voltage is applied, as illustrated in FIG. 7B. A bond 1 is thereby formed between the oxide layer 54d of the separator 54 and the anode member 52. Subsequently, the polarity of the voltage is reversed, and voltage is applied between opposing anode members 52 and cathode members 53 sandwiching the solid electrolyte layer 51, as illustrated in FIG. 7C. A bond 2 is thereby formed between the oxide layer 54c of the separator 54 and the cathode member 53. The laminate that includes the solid electrolyte layer 51, the anode member 52, and the cathode member 53 is thus bonded with the separator 54 to form an integrated whole, yielding the cell stack 50.

Operation of the resulting cell stack 50 is described here. First, an oxidant gas such as air is caused to flow through the oxidant gas flow channels 55, and fuel gas such as hydrogen is caused to flow through the fuel gas flow channels 56. The cell stack 50 is then heated. In the cathode member (air electrode) 53, oxygen included in the oxidant gas then receives electrons from a non-illustrated external circuit, yielding oxygen ions. The generated oxygen ions pass through the solid electrolyte layer 51, migrate to the anode member (fuel electrode) 52, and react with the fuel gas. At this time, electrons are emitted and supplied to the external circuit. Electricity is thereby generated.

Electricity is generated in the cell stack 50 between the anode member 52 and the cathode member 53 sandwiching the solid electrolyte layer 51. The area utilization rate of the solid electrolyte layer 51 is therefore substantially 100%.

### Example 5

### Production of Solid Electrolyte Fuel Cell (SOFC)

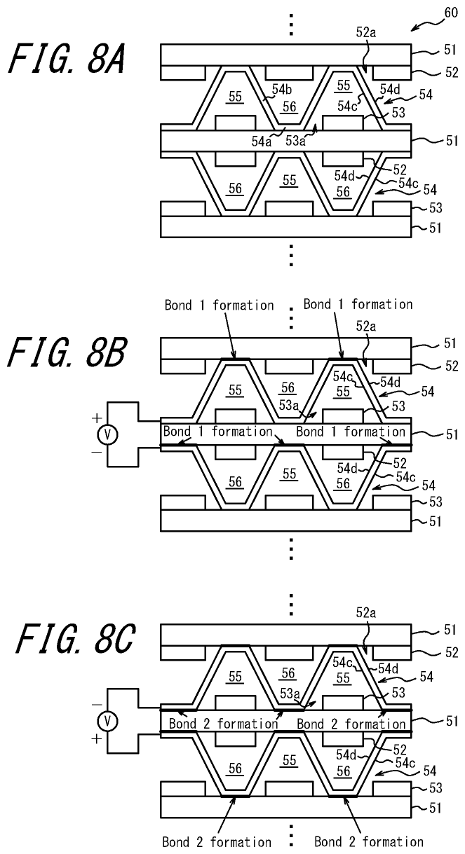

FIGS. 8A to 8C illustrate a cell stack 60 having a similar structure to that of FIGS. 7A to 7C. In FIGS. 8A to 8C, structures that are the same as the cell stack 50 illustrated in FIGS. 7A to 7C are labeled with the same reference signs. The difference between the cell stack 60 illustrated in FIGS. 8A to 8C and the cell stack 50 illustrated in FIGS. 7A to 7C is that the anode member 52 and the cathode member 53 in the cell stack 60 in FIGS. 8A to 8C include a plurality of respective holes 52a, 53a and are in direct contact with the separator 54 and the solid electrolyte layer 51. Problems with bonding strength and sealing properties sometimes occur when the anode member 52 and the cathode member 53 are not dense, so as to obtain gas diffusivity, and are operated under extreme conditions such as repeated intermittent operation. In the present example, the separator 54 is directly bonded to the dense solid electrolyte layer 51, thereby achieving a firm bond with good sealing properties and improving durability under the above-described extreme conditions.

In the case of paste printing, the holes 52a of the anode member 52 and the holes 53a of the cathode member 53 can be formed by using a mask so that the locations where the holes are to be formed are not coated with paste. In the case of a PVD method, the holes 52a, 53a can be formed by photo etching after formation of a single cell.

The cell stack 60 illustrated in FIGS. 8A to 8C can be produced in a similar way as the cell stack 50 illustrated in FIGS. 7A to 7C. In other words, when laminates that include the solid electrolyte layer 51, anode member 52, and cathode member 53 are stacked with separators, then flat plate portions 54a of the separator 54 are disposed in the holes 52a of the anode member 52 or the holes 53a of the cathode member 53 to be in contact with the solid electrolyte layer 51. Like the cell stack 50 illustrated in FIGS. 7A to 7C, DC voltage is applied twice, with a polarity reversal, between separators 54 sandwiching the laminate. As a result, a bond 1 is formed between the oxide layer 54d of the separator 54 and the solid electrolyte layer 51, and a bond 2 is formed between the oxide layer 54c of the separator 54 and the solid electrolyte layer 51. The laminates that include the solid electrolyte layer 51, the anode member 52, and the cathode member 53 are thus bonded firmly with the separator 54 to form an integrated whole, yielding the cell stack 60.

In the cell stack 60 as well, electricity is generated between the anode member 52 and the cathode member 53 sandwiching the solid electrolyte layer 51. The area utilization rate of the solid electrolyte layer 51 is therefore substantially 100%.

### REFERENCE SIGNS LIST

1, 11 Oxygen ion conductor

2 Conductive member

2a, 12a, 13a, 22b, 23b, 31c, 54c, 54d Oxide layer

10 Laminate

12, 13 Metal

20, 22, 23, 30, 32, 33 Pipe

21 Packing

22a, 23a, 32a, 33a End

31 Bonding seal tape

31aMetal tape member

31b Oxygen ion conductor thin film

34 Connecting portion

40 Fuel cell (single cell)

41, 51 Solid electrolyte layer

42, 52 Anode member

43, 53 Cathode member

50, 60 Cell stack

51 Solid electrolyte layer

52a, 53a Hole

54 Separator

54a Flat plate portion

54b Standing plate portion

55 Oxidant gas flow channel

56 Fuel gas flow channel

1. A bonding method comprising:
a placement step of placing an oxygen ion conductor and a conductive member that includes an oxide layer on a surface thereof in contact with each other via the oxide layer;
a connection step of connecting the oxygen ion conductor to a positive electrode side of a voltage application device and connecting the conductive member to a negative electrode side of the voltage application device; and
a voltage application step of applying voltage between the oxygen ion conductor and the conductive member to bond the oxygen ion conductor and the conductive member.

2. The bonding method of claim 1, wherein contact surfaces of the oxygen ion conductor and the conductive member are processed for close contact with each other.

3. The bonding method of claim 1, wherein the oxide layer has electron conductivity.

4. The bonding method of claim 3, wherein the oxide layer is configured by an n-type oxide semiconductor.

5. The bonding method of claim 3, wherein the oxide layer is an insulating film through which electrons can pass in a thickness direction of the insulating film.

6. The bonding method of claim 1, wherein the oxygen ion conductor is an oxide ion conductor.

7. The bonding method of claim 1, wherein
the conductive member is a pipe;
the pipe comprises the oxide layer on a surface thereof, and in the placement step, the oxide layers of two of the pipes are connected to each other via a packing formed by the oxygen ion conductor; and
the voltage application step comprises a first voltage application step of applying voltage of a first polarity between the two pipes to bond one of the two pipes and the packing and a second voltage application step of applying voltage of a second polarity opposite from the first polarity between the two pipes to bond another of the two pipes and the packing.

8. The bonding method of claim 1, wherein
the conductive member is a flexible metal tape member;
the metal tape member, a thin film formed by the oxygen ion conductor provided on one surface of the metal tape member, and the oxide layer provided on another surface of the metal tape member form a bonding seal tape; and
in the placement step, after two pipes are connected at a connecting portion, the bonding seal tape is wound around the connecting portion so that at least a portion of the bonding seal tape is in overlap.

9. The bonding method of claim 1, wherein
the oxygen ion conductor comprises a solid electrolyte layer, an anode member disposed on one surface of the solid electrolyte layer, and a cathode member disposed on another surface of the solid electrolyte layer;
the conductive member is a separator;
the placement step is performed so that a plurality of the oxygen ion conductors and a plurality of the separators are alternately stacked; and
the voltage application step comprises a first voltage application step of applying voltage of a first polarity between two conductive members to bond the oxygen ion conductor and one of the two conductive members and a second voltage application step of applying voltage of a second polarity opposite from the first polarity between the two conductive members to bond the oxygen ion conductor and another of the two conductive members.

10. The bonding method of claim 9,
wherein the anode member and the cathode member each comprise a plurality of holes; and
wherein the placement step is performed so that the separator is placed in contact with the solid electrolyte layer in each of the plurality of holes.

11. The bonding method of claim 1,
wherein the voltage application step is a step of applying direct current voltage; and
the bonding method further comprises an alternating current voltage application step, after the voltage application step, of applying alternating current voltage between the oxygen ion conductor and the conductive member.

12. The bonding method of claim 2, wherein the oxide layer has electron conductivity.

13. The bonding method of claim 12, wherein the oxide layer is configured by an n-type oxide semiconductor.

14. The bonding method of claim 12, wherein the oxide layer is an insulating film through which electrons can pass in a thickness direction of the insulating film.

15. The bonding method of claim 2, wherein the oxygen ion conductor is an oxide ion conductor.

16. The bonding method of claim 3, wherein the oxygen ion conductor is an oxide ion conductor.

17. The bonding method of claim 4, wherein the oxygen ion conductor is an oxide ion conductor.

18. The bonding method of claim 5, wherein the oxygen ion conductor is an oxide ion conductor.
